(19) United States
(12) Patent Application Publication
(10) Pub. No.: US 2024/0301113 A1
(43) Pub. Date: Sep. 12, 2024

(54) RESIN COMPOSITION, ELECTRICALLY CONDUCTIVE ADHESIVE, CURED OBJECT, AND SEMICONDUCTOR DEVICE

(71) Applicant: NAMICS CORPORATION, Niigata (JP)

(72) Inventor: Masayoshi OTOMO, Niigata (JP)

(21) Appl. No.: 18/281,499

(22) PCT Filed: Feb. 28, 2022
(86) PCT No.: PCT/JP2022/008381

§ 371 Date: Sep. 11, 2023

(30) Foreign Application Priority Data
Mar. 18, 2021 (JP) 2021-044683

(51) Int. Cl. C08F 290/06; C09J 4/00; C09J 9/02

(52) U.S. Cl. CPC C08F 290/067; C09J 4/00; C09J 9/02

(57) ABSTRACT

There are provided: a resin composition that has low elasticity, is curable at low temperature, and has a long pot life; an electrically conductive adhesive that contains the resin composition; a cured product of the resin composition; and a semiconductor device that contains the electrically conductive adhesive or the cured product of the resin composition. The resin composition contains (A) a radically polymerizable curable resin, (B) a radical polymerization initiator, and (C) a radical polymerization inhibitor. The (C) component contains (C1) a nitrosamine compound. The (A) component contains (A1) a urethane acrylate oligomer. The (A1) component has a mass average molecular weight of 1,600 or more and 20,000 or less. The resin composition is useful as an electrically conductive adhesive, a material for mounting components or a sealing material for protecting components, and an insulating material for reinforcement which are used in the FHE field.

### TECHNICAL FIELD

The present invention relates to a resin composition used in the field of flexible hybrid electronics (hereinafter, referred to as FHE) and others; an electrically conductive adhesive, a material for mounting components or a sealing material for protecting components, and an insulating material for reinforcement which contain the resin composition; a cured product of the adhesive, sealing material, or insulating material; and a semiconductor device that contains the cured product.

### BACKGROUND ART

In recent years, wearable applications using the Internet have increasingly attracted attention. Mainly in sports and health care fields, applications in the FHE field, such as a biosensor, are being developed.

As wearable applications, biosensors such as wristbands, clothes, or glasses, which are intended to be worn by the human body, are being developed. This requires materials suitable for wearable applications, which can accommodate bending and extension of the surface of the human body.

In these applications, it is necessary to form wiring and mount a sensor, a capacitor, a processor, a memory, and others in imparting electrical functions to everything. In the FHE field, semiconductors such as a processor and a memory to be mounted on a flexible circuit board cannot be imparted with extensibility. Therefore, there is demand for low-elastic electrically conductive adhesives in order to mount these semiconductors on flexible circuit boards.

As an electrically conductive adhesive, for example, PATENT LITERATURE 1 discloses “an electrically conductive resin composition including (A) an epoxy resin, (B) a compound having a (meth)acryloyl group and a glycidyl group, (C) a phenol resin-based curing agent, (D) a radical polymerization initiator, and (E) electrically conductive particles”.

Also, the below-described PATENT LITERATURE 2 discloses “an electrically conductive adhesive including (A) a polyether polymer that contains a main chain having a repeating unit represented by formula: —R¹—O— [where, R¹ is a C1 to C10 hydrocarbon group] and a terminal group that is a hydrolyzable silyl group and (B) silver particles”.

### CITATION LIST

### Patent Literatures

PATENT LITERATURE 1: WO 2013/035685 A
PATENT LITERATURE 2: JP-A-2018-048286

### SUMMARY OF INVENTION

### Problems to be Solved by Invention

However, cured products of these known connection materials have a high elastic modulus. For example, these cured products cannot follow the movement of the human body when applied to applications, such as wearable applications, which require following the movement of humans. Therefore, components may fall off in some cases. In addition, the movement itself of humans may be inhibited.

Also, in general, plastics, thermoplastic polyurethane (TPU), and others, which are used as a substrate in wearable applications, are a material that is weak against heat. Therefore, when electrical functions are imparted to wearable applications, the substrate cannot withstand the temperature of the solder melting point or the curing temperature of the electrically conductive adhesive in a connection method using known solder or a thermocurable epoxy resin-based electrically conductive adhesive. Therefore, the substrate itself can be damaged. Thus, it is important that the electrically conductive adhesive, material for mounting components or sealing material for protecting components, and insulating material for reinforcement which are used for applications in the FHE field are low in elasticity and curable at low temperature. Furthermore, from the viewpoint of workability, a long pot life is also required.

To address these concerns, an object of the present disclosure is, in view of the above-described problems, to provide a resin composition that is low in elasticity and curable at low temperature and has a long pot life, an electrically conductive adhesive that contains the resin composition, a cured product of the resin composition, and a semiconductor device including the electrically conductive adhesive or the cured product of the resin composition. This resin composition is useful as an electrically conductive adhesive, a material for mounting components or a sealing material for protecting components, and an insulating material for reinforcement which are used in the FHE field.

### Solution to Problems

A resin composition according to an embodiment of the present disclosure is a resin composition including (A) a radically polymerizable curable resin, (B) a radical polymerization initiator, and (C) a radical polymerization inhibitor. Also, the (C) component contains (C1) a nitrosamine compound. The (A) component contains (A1) a urethane acrylate oligomer. Furthermore, the (A1) component is a urethane acrylate oligomer having a mass average molecular weight of 1,600 or more and 20,000 or less.

Details of the present embodiment will be explained by the following descriptions of this specification.

According to the present invention, there is provided a resin composition that is useful as an electrically conductive adhesive for mounting components used in the FHE field and curable at low temperature and has low elasticity and a long pot life.

Also, according to the present invention, there are obtained: a resin composition suitable for an electrically conductive adhesive, a material for mounting components or a sealing material for protecting components, and an insulating material for reinforcement which are used in the FHE field; and a cured product of this resin composition. Accordingly, a highly reliable semiconductor device can be obtained.

In particular, the resin composition of the above-described embodiment may contain (C1) the nitrosamine compound as (C) the radical polymerization inhibitor and (A1) the urethane acrylate oligomer having a mass average molecular weight of 1,600 or more and 20,000 or less as (A) the radically polymerizable curable resin. Accordingly, there is obtained a resin composition that is curable at low temperature and has a long pot life. This resin composition is suitable for an electrically conductive adhesive, a material for mounting components or a sealing material for protecting components, and an insulating material for reinforcement which are used in the FHE

### FIELD

In the resin composition of the above-described embodiment, the (B) component contains an organic peroxide having a 10-hour half-life temperature of 165° C. or lower. Further, the content of the (B) component is preferably 0.1 part by mass to 30 parts by mass with respect to 100 parts by mass of the (A) component. By containing an organic peroxide having a 10-hour half-life temperature of 165° C. or lower, the present resin composition can be cured at relatively low temperature.

In the resin composition of the above-described embodiment, the (A) component preferably further contains (A3) a bismaleimide resin. By containing (A3) the bismaleimide resin, suitable stability such as heat resistance and moisture resistance as well as flexibility can be obtained.

In the resin composition of the above-described embodiment, the (A) component preferably further contains (A2) an acrylate monomer. More preferably, (A2) the acrylate monomer in the resin composition contains an acrylate monomer having a glass transition temperature (Tg) of 15° C. or higher. Particularly preferably, the mass ratio between (A1) the urethane acrylate oligomer and (A2) the acrylate monomer is 5:95 to 60:40. By containing (A2) the acrylate monomer, workability improves. Also, an appropriate storage elastic modulus can be imparted to the resin composition.

In the resin composition of the above-described embodiment, (A1) the urethane acrylate oligomer is preferably contained in an amount of 5 parts by mass to 50 parts by mass with respect to 100 parts by mass of the (A) component. When (A1) the urethane acrylate oligomer is within this range, excellent flexibility can be imparted to the resin composition without loss of workability and reactivity.

In the resin composition of the above-described embodiment, the content of the (C) component is preferably 0.1 part by mass to 5 parts by mass with respect to 100 parts by mass of the (B) component. This can suppress an unintended radical polymerization reaction.

The normal-temperature elastic modulus of the resin composition according to the above-described embodiment after left to stand at 70° C. for 60 minutes is 0.01 GPa to 1.6 GPa. This allows the cured product of the resin composition to have excellent flexibility and extensibility.

The resin composition of the above-described embodiment preferably contains insulating particles or electrically conductive particles. This allows the resin composition to be used in the FHE applications, particularly as an electrically conductive adhesive and a cured product of a sealing material, an insulating material, or the like. The electrically conductive adhesive and the cured product are suitably used in a semiconductor device.

### DESCRIPTION OF EMBODIMENTS

Hereinafter, a resin composition according to an embodiment of the present disclosure will be described. However, the present embodiment is not limited to the below-described embodiment.

### <Resin Composition>

A resin composition according to an embodiment of the present disclosure (hereinafter, referred to as the present resin composition) includes (A) a radically polymerizable curable resin, (B) a radical polymerization initiator, and (C) a radical polymerization inhibitor. The (C) component contains (C1) a nitrosamine compound. The (A) component contains (A1) a urethane acrylate oligomer. The (A1) component is a urethane acrylate oligomer having a mass average molecular weight of 1,600 or more and 20,000 or less.

### <(A) Radically Polymerizable Curable Resin>

(A) The radically polymerizable curable resin refers to a resin that is cured by the proceeding of radical polymerization. Curable resin imparts curing properties and others to the present resin composition. Radically polymerizable curable resin has a high polymerization rate. Therefore, curing can be rapidly performed. Such a curable resin is not particularly limited as long as it is radically polymerizable. Also, radically polymerizable curable resin is preferably liquid. Use of liquid curable resin eliminates a solvent. This suppresses occurrence of voids in a resin composition. When a solvent is used, the amount of the solvent with respect to 100 parts by mass of the present resin composition is preferably less than 3 parts by mass, more preferably less than 1 part by mass, and most preferably no solvent.

Examples of (A) the radically polymerizable curable resin may include (A1) the urethane acrylate oligomer, (A2) an acrylate monomer, and (A3) a bismaleimide resin.

The present resin composition contains at least (A1) the urethane acrylate oligomer. The present resin composition may further contain one or both of (A2) the acrylate monomer and (A3) the bismaleimide resin.

The content of (A) the radically polymerizable curable resin in 100 parts by mass of the present resin composition is preferably 5 parts by mass to 90 parts by mass, more preferably 8 parts by mass to 30 parts by mass, and particularly preferably 8 parts by mass to 20 parts by mass.

### <(A1) Urethane Acrylate Oligomer>

As (A1) the urethane acrylate oligomer, a urethane acrylate oligomer having a mass average molecular weight of 1,600 or more and 20,000 or less can be used. Use of (A1) the urethane acrylate oligomer having a mass average molecular weight in this range allows the present resin composition after curing to have low elasticity and good extensibility without loss of workability and reactivity of the present resin composition. From such a viewpoint, the mass average molecular weight is preferably 1,600 or more and 20,000 or less, more preferably 2,000 or more and 18,000 or less, and particularly preferably 3,000 or more and 15,000 or less. One type of (A1) the urethane acrylate oligomer may be used singly. Alternatively, a mixture of two or more types of (A1) the urethane acrylate oligomers may be used. Also, (A1) the urethane acrylate oligomers having different mass average molecular weights may be used in combination. However, when (A1) the urethane acrylate oligomer having a mass average molecular weight of more than 20,000 is contained, workability may deteriorate because of high viscosity. At the same time, reactivity can also deteriorate because of steric hindrance. Therefore, it is preferable that (A1) the urethane acrylate oligomer having a mass average molecular weight of more than 20,000 is not substantially contained. It is also preferable that (A1) the urethane acrylate oligomer having a mass average molecular weight of less than 1,600 is not substantially contained.

As described herein, “not substantially contained” means not to be intentionally contained in the present composition. Specifically, it means that the content in the present composition is less than 0.1% by mass.

The mass average molecular weight in the present disclosure can be measured by gel permeation chromatography. The number of functional groups in (A1) the urethane acrylate oligomer is preferably 1 to 5, more preferably 1 to 4, and further preferably 1 to 3. When the number of functional groups is within this range, the crosslink density of a cured product of a resin composition decreases. Furthermore, good flexibility and extensibility can be imparted to a resin composition.

Specific examples of a used commercially available product of (A1) the urethane acrylate oligomer include “MBA-2CZ” (mass average molecular weight: 1,600), “UN-333” (3,000), “UN-6200” (mass average molecular weight: 6,500), and “UN-6304” (mass average molecular weight: 13,000) as urethane acrylate oligomers manufactured by Negami Chemical Industrial Co., Ltd. as well as “UV-3200B” (mass average molecular weight: 10,000) and “UV-3000B” (mass average molecular weight: 18,000) as urethane acrylate oligomers manufactured by Mitsubishi Chemical Corporation.

The content of (A1) the urethane acrylate oligomer with respect to 100 parts by mass of (A) the radically polymerizable curable resin is preferably 5 parts by mass to 50 parts by mass. When this content rate is less than 5 parts by mass, the normal-temperature elastic modulus of a resin composition increases. Therefore, the flexibility of a resin composition may be lost. Also, when the content rate exceeds 50 parts by mass, the low-temperature curing properties and workability of a resin composition deteriorate.

From such a viewpoint, the content of (A1) the urethane acrylate oligomer with respect to 100 parts by mass of (A) the radically polymerizable curable resin is more preferably 6 parts by mass to 30 parts by mass and particularly preferably 7 parts by mass to 20 parts by mass.

### <(A2) Acrylate Monomer>

The present resin composition may contain (A2) the acrylate monomer.

(A2) The acrylate monomer is not particularly limited. Preferable examples thereof include monofunctional acrylate monomers such as phenoxy ethyl acrylate and isobornyl acrylate. Also, in the case of a multifunctional acrylate monomer having two or more (meth)acryloyl groups in one molecule, it is preferable that a C4 to C30 linear alkylene backbone or a C4 to C30 linear oxyalkylene backbone is contained between the neighboring (meth)acryloyl groups. When the present resin composition contains (A2) the acrylate monomer, the normal-temperature elastic modulus and workability improve.

From the viewpoint of imparting flexibility to a cured product, (A2) the acrylate monomer preferably contains an acrylate monomer having a glass transition temperature (Tg) of 15° C. or lower. On the other hand, when only an acrylate monomer having a glass transition temperature (Tg) of 15° C. or lower is contained, oxygen inhibition on the surface of a cured product is significant. Therefore, unnecessary tack (stickiness) may occur in some cases. In this case, it is preferable that an acrylate monomer having a glass transition temperature (Tg) of 15° C. or higher is contained in combination. When an acrylate monomer having a glass transition temperature (Tg) of 15° C. or higher is contained, occurrence of tack caused by oxygen inhibition on the surface of a cured product can be reduced. It is noted that from the viewpoint of imparting flexibility, the content of an acrylate monomer having a glass transition temperature (Tg) of 15° C. or lower is higher than that of an acrylate monomer having a glass transition temperature (Tg) of 15° C. or higher. The glass transition temperature (Tg) of an acrylate monomer can be measured as the glass transition temperature (Tg) of a homopolymer by dynamic viscoelastic measurement (DMA) or a thermal mechanical analyzer (TMA). One type of (A2) the acrylate monomer may be used singly. Alternatively, a mixture of two or more types of (A2) the acrylate monomers may be used.

Specific examples of (A2) the acrylate monomer used include “Light Acrylate PO-A” (Tg: −22° C.) as phenoxy ethyl acrylate and “Light Acrylate IB-XA” (Tg: 94° C.) as isobornyl acrylate manufactured by Kyoeisha Chemical Co., Ltd.

The content of (A2) the acrylate monomer with respect to 100 parts by mass of (A) the radically polymerizable curable resin is preferably 3 parts by mass to 75 parts by mass. When the content is less than 3 parts by mass, viscosity increases. This reduces handleability and thus deteriorates workability. When the content exceeds 75 parts by mass, the crosslink density increases. This tends to increase the elastic modulus, that is, to reduce flexibility.

From such a viewpoint, the content of (A2) the acrylate monomer with respect to 100 parts by mass of (A) the radically polymerizable curable resin is more preferably 25 parts by mass to 70 parts by mass and particularly preferably 30 parts by mass to 65 parts by mass.

The preferable mass ratio (A1:A2) between (A2) the acrylate monomer and (A1) the urethane acrylate oligomer is 5:95 to 60:40. When the mass ratio is within this range, appropriate viscosity of a resin composition is retained. That is, handleability of a resin composition improves. Therefore, good workability is retained. Moreover, an excellent cured product having extensibility and low elasticity is obtained. From such a viewpoint, the mass ratio (A1:A2) is more preferably 7:93 to 50:50 and particularly preferably 10:90 to 30:70.

### <(A3) Bismaleimide Resin>

The present resin composition may contain (A3) the bismaleimide resin. Bismaleimides used in the present embodiment may include solid bismaleimide. However, it is more preferable to use liquid bismaleimide. Solid bismaleimides have low solubility to common organic solvents. Accordingly, when solid bismaleimides are used, dilution with a large quantity of an organic solvent is necessary. However, in this case, the solvent volatized during curing sometimes forms voids. The voids lead to a decrease in adhesive strength and occurrence of cracks. For avoiding this, there is also a method of dispersing solid bismaleimides in a resin composition using a roll mill or the like. However, this method increases the viscosity of a resin composition. On the other hand, a resin composition that contains liquid bismaleimide has low viscosity. This improves workability during use of a resin composition.

(A3) The bismaleimide resin is not particularly limited. Any compound having a chemical structure of being sandwiched between two maleimide groups can be used. When (A3) the bismaleimide resin is contained in the present resin composition, a cured product that is excellent in stability (heat resistance and moisture resistance) while maintaining flexibility can be obtained.

From such a viewpoint, the mass average molecular weight of (A3) the bismaleimide resin is preferably 500 to 7000, more preferably 750 to 5500, and particularly preferably 1000 to 3000. Further, as (A3) the bismaleimide resin, dimer acid-modified bismaleimide can also be used. Examples of the dimer acid-modified bismaleimide include BMI-1500 and BMI-1700 as liquid bismaleimide as well as BMI-3000 as solid bismaleimide (all are manufactured by Designer Molecules Inc.). Use of the dimer acid-modified bismaleimide can lower the normal-temperature elastic modulus of a resin composition. It is considered that this is because the dimer acid-modified bismaleimide has a reactive maleimide group only at both terminals, and thus a crosslinkable reactive group does not exist in the molecular chain.

One type of (A3) the bismaleimide resin may be used singly. Alternatively, a mixture of two or more types of (A3) the bismaleimide resins may be used.

The content of (A3) the bismaleimide resin with respect to 100 parts by mass of (A) the radically polymerizable curable resin is preferably 5 parts by mass to 40 parts by mass. When the content is less than 5 parts by mass, reliability and strength decrease. When the content exceeds 40 parts by mass, flexibility is lost. From such a viewpoint, the content of (A3) the bismaleimide resin with respect to 100 parts by mass of (A) the radically polymerizable curable resin is more preferably 10 parts by mass to 35 parts by mass and particularly preferably 15 parts by mass to 30 parts by mass.

The mass ratio (A1:A3) between (A3) the bismaleimide resin and (A1) the urethane acrylate oligomer is preferably 10:90 to 80:20. When the mass ratio is within this range, not only reliability and strength but also flexibility can be maintained.

From such a viewpoint, the mass ratio (A1:A3) is more preferably 15:85 to 70:30 and particularly preferably 20:80 to 60:40.

### <(B) Radical Polymerization Initiator>

(B) The radical polymerization initiator initiates radical polymerization of (A) the radically polymerizable curable resin to cure the resin. From the viewpoint of reactivity with (A) the radically polymerizable curable resin, (B) the radical polymerization initiator is preferably an organic peroxide.

Examples of the organic peroxide to be used include peroxydicarbonate, 1,1,3,3-tetramethylbutylperoxy-2-ethyl hexanoate, t-butylcumyl peroxide, dicumyl peroxide, dilauroyl peroxide, dibenzoyl peroxide, 1,1-di(t-hexylperoxy)cyclohexane, 2,5-dimethyl-2,5-di(t-butylperoxy)hexane, t-butylperoxy-2-ethylhexyl monocarbonate, α,α′-di(t-butylperoxy)diisopropyl benzene, n-butyl 4,4-di(t-butylperoxy)valerate, t-hexylperoxyisopropyl monocarbonate, t-butylperoxy laurate, and 2-di(t-butylperoxy)butane. One type of (B) the radical polymerization initiator may be used singly. Alternatively, a mixture of two or more types of (B) the radical polymerization initiators may be used.

The organic peroxide as (B) the radical polymerization initiator preferably has a 10-hour half-life temperature of 165° C. or lower. This allows the present resin composition to be cured at relatively low temperature. From such a viewpoint, the 10-hour half-life temperature is more preferably 120° C. or lower and particularly preferably 100° C. or lower. Also, the lower limit value is, but not particularly limited to, preferably 28° C. or higher, more preferably 30° C. or higher, and particularly preferably 35° C. or higher.

It is noted that the 10-hour half-life temperature refers to a temperature at which a time until an organic peroxide is decomposed so that the half (½) of its amount is lost is 10 hours. When the 10-hour half-life temperature is lower than 28° C., reactivity becomes excessively high, which may reduce the stability of the reaction.

Specific examples of (B) the radical polymerization initiator to be used include “Peroyl TCP” (10-hour half-life temperature: 40.8° C.) as peroxydicarbonate, “Perocta O” (10-hour half-life temperature: 65.3° C.) as 1,1,3,3-tetramethylbutylperoxy-2-ethyl hexanoate, “Perbutyl C” (10-hour half-life temperature: 119.5° C.) as t-butylcumyl peroxide, “Percumyl D” (10-hour half-life temperature: 116.4° C.) as dicumyl peroxide, “Peroyl L” (10-hour half-life temperature: 61.6° C.) as dilauroyl peroxide, “Nyper FF” (10-hour half-life temperature: 73.6° C.) as dibenzoyl peroxide, “Perhexa HC” (10-hour half-life temperature: 87.1° C.) as 1,1-di(t-hexylperoxy)cyclohexane, “Perhexa 25B” (10-hour half-life temperature: 117.9° C.) as 2,5-dimethyl-2,5-di(t-butylperoxy)hexane, “Perbutyl E” (10-hour half-life temperature: 99.0° C.) as t-butylperoxy-2-ethylhexyl monocarbonate, “Perbutyl P” (10-hour half-life temperature: 119.2° C.) as α,α′-di(t-butylperoxy)diisopropyl benzene, “Perhexa V” (10-hour half-life temperature: 104.5° C.) as n-butyl 4,4-di(t-butylperoxy)valerate, “Perhexyl I” (10-hour half-life temperature: 95.0° C.) as t-hexylperoxyisopropyl monocarbonate, “Perbutyl L” (10-hour half-life temperature: 98.3° C.) as t-butylperoxy laurate, and “Perhexa 22” (10-hour half-life temperature: 103.1° C.) as 2,2-di(t-butylperoxy)butane, which are manufactured by Nof Corporation.

(B) The radical polymerization initiator with respect to 100 parts by mass of (A) the radically polymerizable curable resin is preferably 0.1 part by mass to 30 parts by mass, more preferably 3 parts by mass to 20 parts by mass, and particularly preferably 6 parts by mass to 15 parts by mass. When (B) the radical polymerization initiator is excessively large in amount, (B) the radical polymerization initiator unreacted may remain in the cured product of the present resin composition after curing of the present resin composition. In that case, the residual heat generation may occur.

### <(C) Radical Polymerization Inhibitor>

(C) The radical polymerization inhibitor suppresses radical polymerization of (A) the radically polymerizable curable resin to extend the pot life of the present resin composition. The pot life refers to a time during which the usable state of the present resin composition is maintained.

Examples of (C) the radical polymerization inhibitor to be used include a nitrosamine compound such as aluminum salt of nitrosamine as well as hydroquinone and 2,2,6,6-tetramethyl-1-oxyl. Among these, a nitrosamine compound such as nitrosophenylhydroxyamine aluminum salt is preferable. This can prevent an unintended radical polymerization reaction at room temperature (normal temperature) without inhibiting the reaction.

One type of (C) the radical polymerization inhibitor may be used singly. Alternatively, a mixture of two or more types of (C) the radical polymerization inhibitors may be used. However, only a nitrosamine compound is preferably used.

Specific examples of (C) the radical polymerization inhibitor which is commercially available include “Q1301” as aluminum salt of nitrosamine and “HQ” as hydroquinone manufactured by Fujifilm Wako Pure Chemical Corporation as well as “TEMPO” as 2,2,6,6-tetramethyl-1-oxyl manufactured by Koei Chemical Co., Ltd.

The content of (C) the radical polymerization inhibitor with respect to 100 parts by mass of (B) the radical polymerization initiator is preferably 0.1 to 5 parts by mass, more preferably 0.5 part by mass to 1.7 parts by mass, and particularly preferably 0.9 part by mass to 1.3 parts by mass. When the content is within this range, the radical polymerization of (A) the radically polymerizable curable resin is appropriately suppressed, while the reaction during curing is not inhibited. In this manner, an unintended radical polymerization reaction at room temperature (normal temperature) can be suppressed.

### <Other Components>

The present resin composition may contain other components. For example, (D1) electrically conductive particles or (D2) insulating particles can be contained. One type of (D1) the electrically conductive particles or one type of (D2) the insulating particles may be used singly. Alternatively, a mixture of two or more types of (D1) the electrically conductive particles or a mixture of two or more types of (D2) the insulating particles may be used.

### <(D1) Electrically Conductive Particles>

In the present invention, (D1) the electrically conductive particles refer to particles having an average particle size of 0.01 μm to 100 μm and an electrical conductivity of 106 S/m or more. An electrically conductive substance formed in a particulate form can be used. Alternatively, nuclei (core particles) coated with an electrically conductive substance may be used. The nuclei (core particles) may be formed of an electrically non-conductive substance if they are at least partly coated with an electrically conductive substance. Examples of (D1) the electrically conductive particles include metal powder and coat powder.

(D1) The electrically conductive particles are used for imparting thermal conductivity and/or electrical conductivity to the present resin composition. The electrically conductive substance is not particularly limited. Examples of such an electrically conductive substance include gold, silver, nickel, copper, palladium, platinum, bismuth, tin, alloys thereof (particularly, bismuth-tin alloy, solder, and others), aluminum, indium tin oxide, silver-coated copper, silver-coated aluminum, metal-coated glass balls, silver-coated fiber, silver-coated resin, antimony-doped tin, tin oxide, carbon fiber, graphite, carbon black, and a mixture thereof.

In consideration of thermal conductivity and electrical conductivity, the electrically conductive substance preferably contains at least one metal selected from the group consisting of silver, nickel, copper, tin, aluminum, silver alloy, nickel alloy, copper alloy, tin alloy, and aluminum alloy. More preferably, the electrically conductive substance contains at least one metal selected from the group consisting of silver, copper, and nickel. The electrically conductive substance further preferably contains silver or copper and most preferably silver.

In an aspect, (D1) the electrically conductive particles are silver particles. In another aspect, (D1) the electrically conductive particles are copper particles. The silver particles and copper particles contain coat particles as core particles coated with silver and copper, respectively, as defined above. Specific examples of (D1) the electrically conductive particles to be used include “EA79613” and “K79121P” as silver powder manufactured by Metalor Technologies.

The content of (D1) the electrically conductive particles with respect to 100 parts by mass of the present resin composition is typically 95 parts by mass or less and preferably 92 parts by mass or less. In an aspect, the content of (D1) the electrically conductive particles with respect to 100 parts by mass of the present resin composition is 10 parts by mass to 95 parts by mass and typically 20 parts by mass to 95 parts by mass. In another aspect, the content of (D1) the electrically conductive particles with respect to the total mass parts of the present resin composition is 50 parts by mass to 95 parts by mass and typically 80 parts by mass to 95 parts by mass.

The shape of (D1) the electrically conductive particles is not particularly limited. Electrically conductive particles having any shape such as spherical, indefinite, flake-like (scale-like), filament-like (needle-lie), or dendritic can be used. Here, the flake-like shape refers to a shape having a “major axis/minor axis” ratio (aspect ratio) of 2 or more. The flake-like shape includes a flat plate-like shape such as a plate-like or scale-like shape. The major axis and minor axis of a particle constituting electrically conductive particles can be obtained based on an image obtained through a scanning electron microscope (SEM) (n=20). The “major axis” refers to a diameter having the longest distance among lines that pass the substantial center of gravity of a particle in an image of particles obtained through the SEM. The “minor axis” refers to a diameter having the shortest distance among lines that pass the substantial center of gravity of a particle in an image of particles obtained through the SEM.

It is noted that a combination of particles having different shapes may be used.

When (D1) the electrically conductive particles are silver particles, the tap density thereof is preferably 1.5 g/cm³ or more and more preferably 2.0 g/cm³ to 6.0 g/cm³. Here, the tap density can be measured in accordance with JIS Z 2512 metal powder-tap density measurement method. When the tap density of silver particles is excessively low, it is difficult to disperse the silver particles in the cured product of the present resin composition with high density. As a result, the electrical conductivity of the cured product is likely to decrease. On the other hand, when the tap density of silver particles is excessively high, the silver particles are likely to separate and settle down in the present resin composition.

When (D1) the electrically conductive particles are silver particles, the average particle size (D₅₀) thereof is preferably 0.05 μm to 50 μm, more preferably 0.1 μm to 20 μm, and particularly preferably 0.1 μm to 15 μm, from the viewpoint of the electrical conductivity and the fluidity of the present resin composition. Here, the average particle size refers to a particle size (median diameter) that indicates 50% cumulative frequency in a volume-based particle size distribution measured by a laser diffraction method.

When (D1) the electrically conductive particles are silver particles, the specific surface area of the silver particles is preferably 4.0 m²/g or less and more preferably 0.1 m²/g to 3.0 m²/g. Here, the specific surface area can be measured by a BET method. When the specific surface area of silver particles is excessively large, the viscosity increases when formed into a paste. This is likely to reduce handleability. On the other hand, when the specific surface area of silver particles is excessively small, the contact surface among the silver particles decreases, and thus the electrical conductivity deteriorates.

### <(D2) Insulating Particles>

As (D2) the insulating particles, insulating particles such as silica particles can be used. Specific examples of (D2) the insulating particles to be used include “SE5200SEE” (average particle size: 2 μm) as high purity synthesis spherical silica manufactured by Admatechs Company Limited and “TS720” as hydrophobic fumed silica manufactured by Cabot Corporation.

The content of (D2) the insulating particles in 100 parts by mass of the present resin composition is preferably 0.1 part by mass to 80 parts by mass, more preferably 1 part by mass to 75 parts by mass, and particularly preferably 10 parts by mass to 70 parts by mass.

When (D2) the insulating particles are silica particles, the average particle size (D₅₀) thereof is preferably 0.01 μm to 20 μm, more preferably 0.05 μm to 15 μm, and particularly preferably 0.1 μm to 10 μm. Here, the average particle size refers to a particle size (median diameter) that indicates 50% cumulative frequency in a volume-based particle size distribution measured by a laser diffraction method.

### <Physical Property Values>

### <<Viscosity>>

The viscosity of the present resin composition can be measured at a measurement temperature of 25° C. using a Brookfield RVT-type viscometer (spindle: SC4-14 spindle). The measured viscosity is preferably 5 Pas to 100 Pas, more preferably 10 Pa·s to 100 Pa·s, and particularly preferably 15 Pa·s to 90 Pa·s. The viscosity of the present resin composition can be adjusted by, for example, adjusting the viscosity of a monomer component, adjusting the viscosity of an oligomer component, adding a solvent, adding a reactive diluent, or the formulation amount of inorganic particles.

### <<Die Shear Strength>>

The die shear strength of the present resin composition is preferably 2 N/mm² or more, more preferably 3 N/mm² or more, and particularly preferably 4 N/mm² or more. The die shear strength of the present resin composition can be adjusted by, for example, the molecular structure, molecular weight, or formulation amount of a monomer component and an oligomer component.

### <<Normal-Temperature Elastic Modulus>>

The “normal-temperature elastic modulus” is the index of flexibility at normal temperature indicated by a cured product of a certain resin composition. It can be said that the lower the normal-temperature elastic modulus, the higher the flexibility. The normal-temperature elastic modulus of the present resin composition after left to stand at 70° C. for 60 minutes is preferably 0.01 GPa to 1.6 GPa, more preferably 0.1 GPa to 1.5 GPa, and particularly preferably 0.2 GPa to 1.0 GPa. The normal-temperature elastic modulus of the present resin composition can be adjusted by, for example, the molecular structure, molecular weight, or formulation amount of a monomer component and an oligomer component.

### <<Pot Life>>

The “pot life” refers to a time period during which an adhesive composition maintains its usable state after preparation thereof. The pot life of the present resin composition is preferably 6 hours [h] or more, more preferably 8 hours [h] or more, and particularly preferably 12 hours [h] or more. The pot life of the present resin composition can be adjusted by, for example, the formulation amounts of (B) the radical polymerization initiator and (C) the radical polymerization inhibitor.

### <Production Method>

The present resin composition can be produced by formulating (A) the radically polymerizable curable resin, (B) the radical polymerization initiator, and (C) the radical polymerization inhibitor, and, as necessary, insulating particles or electrically conductive particles as well as a surface treatment agent such as a coupling agent, a pigment, a plasticizer, and/or the like, and stirring and mixing the mixture.

A known apparatus can be used for the stirring and mixing of the mixture. For example, the mixing can be performed using a known apparatus such as a Henschel mixer, a roll mill, or a triple roll mill. These raw materials can be simultaneously mixed. Alternatively, a part of the raw materials may be mixed first, and thereafter the remaining may be mixed. The preparation method of the present resin composition is not particularly limited as long as each material is sufficiently kneaded.

### (Supplying Method)

The present resin composition can be applied using, for example, a jet dispenser or an air dispenser. Also, there can be used a known coating method (for example, dip coating, spray coating, bar coater coating, gravure coating, reverse gravure coating, and spin coater coating) and a known printing method (for example, lithographic printing, Carton printing, metal printing, offset printing, screen printing, gravure printing, flexo printing, and ink-jet printing).

### (Curing Conditions)

The present resin composition can be cured by, for example, heating at a temperature of 60° C. to 150° C. The heating temperature is preferably 65° C. to 120° C. and more preferably 70° C. to 100° C. The heating time is preferably 0.25 hour to 4 hours and more preferably 0.5 hour to 2 hours.

### <Uses>

The present resin composition has low elasticity, is excellent in low-temperature curing properties, and has a long pot life. From such a viewpoint, the present resin composition can be used for, for example, the flexible⋅hybrid-electronics (FHE) field. The present resin composition is suitable for precision components such as electronic components and semiconductor circuits used in optical components and semiconductor devices. More specifically, electrically conductive materials such as an electrically conductive adhesive prepared from the present resin composition that contains electrically conductive particles or a cured product obtained by curing the present resin composition can be used as a material for mounting components, a sealing material for protecting components, or an insulating material for reinforcement.

### EXAMPLES

Hereinafter, a resin composition according to an embodiment of the present disclosure will be described. However, the present embodiment is not limited to the below-described examples.

For preparing the resin compositions of Examples and Comparative Examples, the following materials were used.

### <Materials>

1. (A) Radically polymerizable curable resin
(A1) Urethane acrylate oligomer
(A1-1) Urethane acrylate oligomer “MBA-2CZ”: molecular weight 1,600 (Negami Chemical Industrial Co., Ltd.)
(A1-2) Urethane acrylate oligomer “UN-333”: molecular weight 3,000 (Negami Chemical Industrial Co., Ltd.)
(A1-3) Urethane acrylate oligomer “UN-6200”: molecular weight 6,500 (Negami Chemical Industrial Co., Ltd.)
(A1-4) Urethane acrylate oligomer “UV-3200B”: molecular weight 10,000 (Mitsubishi Chemical Corporation)
(A1-5) Urethane acrylate oligomer “UN-6304”: molecular weight 13,000 (Negami Chemical Industrial Co., Ltd.)
(A1-6) Urethane acrylate oligomer “UV-3000B”: molecular weight 18,000 (Mitsubishi Chemical Corporation)
(A1-7) Urethane acrylate oligomer “UN-3320HA”: molecular weight 1,500 (Negami Chemical Industrial Co., Ltd.)
(A1-8) Urethane acrylate oligomer “UN6207”: molecular weight 27,000 (Negami Chemical Industrial Co., Ltd.)
(A2) Acrylate monomer
(A2-1) Acrylic resin “Light Acrylate PO-A” (Kyoeisha Chemical Co., Ltd.) (A2-2) Acrylic resin “Light Acrylate IB-XA” (Kyoeisha Chemical Co., Ltd.)
(A3) Bismaleimide resin
(A3-1) Bismaleimide resin “BMI-1500” (liquid, dimer acid-modified) (Designer molecules Inc.)
(B) Radical polymerization initiator
(B-1) Peroxydicarbonate “Peroyl TCP”: 10-hour half-life temperature 40.8° C. (Nof Corporation)
(B-2) Dicumyl peroxide “Percumyl D”: 10-hour half-life temperature 119.5° C. (Nof Corporation)
(C) Radical polymerization inhibitor
(C-1) Nitrosophenylhydroxyamine aluminum salt (NNAS) “Q1301” (Fujifilm Wako Pure Chemical Corporation)
(C-2) Hydroquinone “HQ” (Fujifilm Wako Pure Chemical Corporation)
(C-3) 2,2,6,6-tetramethyl-1-piperidinyloxy “TEMPO” (Koei Chemical Co., Ltd.)
(D1) Electrically conductive particles
(D1-1) Silver powder “EA79613”: average particle size 7 μm (Metalor Technologies Co.)
(D1-2) Silver powder “K79121P”: average particle size 1 μm (Metalor Technologies Co.)
(D2) Insulating particles
(D2-1) Silica “SES200SEE”: average particle size 2 μm (Admatechs Company Limited)
(D2-2) Silica “TS720”: average particle size 0.3 μm (Cabot Corporation)

### Production of Examples and Comparative Examples

The resin compositions of Examples 1 to 19 and Comparative Examples 1 to 5 were produced by formulating materials to have the formulation ratios illustrated in Tables 1 to 3 below and stirring and mixing the formulated materials using a triple roll mill.

TABLE 1

| | | Exam- | Exam- | Exam- | Exam- | Exam- | Exam- | Exam- | Exam- | Exam- | Exam- |
|---|---|---|---|---|---|---|---|---|---|---|---|
| | | ple 1 | ple 2 | ple 3 | ple 4 | ple 5 | ple 6 | ple 7 | ple 8 | ple 9 | ple 10 |
| (A) Radically polymerizable | A1-1 | | | 1.27 | | | | | | | |
| curable resin | A1-2 | | | | 1.27 | | | | | | |
| | A1-3 | 1.27 | 1.27 | | | 0.67 | 6.72 | | | | 1.27 |
| | A1-4 | | | | | | | 1.27 | | | |
| | A1-5 | | | | | | | | 1.27 | | |
| | A1-6 | | | | | | | | | 1.27 | |
| | A1-7 | | | | | | | | | | |
| | A1-8 | | | | | | | | | | |
| | A2-1 | 6.54 | 6.54 | 6.54 | 6.54 | 6.86 | 3.61 | 6.54 | 6.54 | 6.54 | 6.54 |
| | A2-2 | 1.75 | 1.75 | 1.75 | 1.75 | 1.84 | 0.97 | 1.75 | 1.75 | 1.75 | 1.75 |
| | A3-3 | 3.88 | 3.88 | 3.88 | 3.88 | 4.07 | 2.14 | 3.88 | 3.88 | 3.88 | 3.88 |
| (B) Radical polymerization | B-1 | 1.35 | 1.35 | 1.35 | 1.35 | 1.35 | 1.35 | 1.35 | 1.35 | 1.35 | 1.35 |
| initiator | B-2 | | | | | | | | | | |
| (C) Radical polymerization | C-1 | 0.013 | 0.017 | 0.017 | 0.017 | 0.017 | 0.017 | 0.017 | 0.017 | 0.017 | 0.008 |
| inhibitor | C-2 | | | | | | | | | | |
| | C-3 | | | | | | | | | | |
| (D1) Electrically conductive | D1-1 | 43.00 | 43.00 | 43.00 | 43.00 | 43.00 | 43.00 | 43.00 | 43.00 | 43.00 | 43.00 |
| particles | D1-2 | 43.00 | 43.00 | 43.00 | 43.00 | 43.00 | 43.00 | 43.00 | 43.00 | 43.00 | 43.00 |
| (D2) Insulating particles | D2-1 | | | | | | | | | | |
| | D2-2 | | | | | | | | | | |

| | | | | | | | | | | |
|---|---|---|---|---|---|---|---|---|---|---|
| 70° C. Curing properties | A | A | A | A | A | A | A | A | A | A |
| Viscosity [Pa · s] | 27 | 25 | 21 | 23 | 24 | 49 | 30 | 37 | 46 | 27 |
| Die shear strength [N/mm²] | 6.7 | 6.5 | 8.2 | 7 | 7.2 | 4.7 | 6.8 | 5.1 | 4 | 6.4 |
| Normal-temperature elastic modulus [GPa] | 0.6 | 0.5 | 0.8 | 0.6 | 0.8 | 0.4 | 0.6 | 0.5 | 0.4 | 0.7 |
| Pot life [hour h] | 30 | 30 | 24 | 30 | 30 | 48 | 30 | 30 | 48 | 24 |
| Overall evaluation | A | A | A | A | A | A | A | A | A | A |

TABLE 2

| | | Exam- | Exam- | Exam- | Exam- | Exam- | Exam- | Exam- | Exam- | Exam- |
|---|---|---|---|---|---|---|---|---|---|---|
| | | ple 11 | ple 12 | ple 13 | ple 14 | ple 15 | ple 16 | ple 17 | ple 18 | ple 19 |
| (A) Radically polymerizable | A1-1 | | | | | | | | | |
| curable resin | A1-2 | | 0.64 | | | | | | | |
| | A1-3 | 1.27 | | 1.32 | 1.02 | 1.27 | 1.81 | 0.73 | 7.79 | 2.64 |
| | A1-4 | | | | | | | | | |
| | A1-5 | | 0.64 | | | | | | | |
| | A1-6 | | | | | | | | | |
| | A1-7 | | | | | | | | | |
| | A1-8 | | | | | | | | | |
| | A2-1 | 6.54 | 6.54 | 6.80 | 5.23 | 6.54 | 9.34 | 3.74 | 40.11 | 13.61 |
| | A2-2 | 1.75 | 1.75 | 1.82 | 1.40 | 1.75 | 2.50 | 1.00 | 10.73 | 3.64 |
| | A3-3 | 3.88 | 3.88 | 4.04 | 3.11 | 3.88 | 5.54 | 2.22 | 23.80 | 8.07 |
| (B) Radical polymerization | B-1 | 1.35 | 1.35 | 0.80 | 4.00 | | 1.93 | 0.77 | 8.28 | 2.81 |
| initiator | B-2 | | | | | 1.35 | | | | |
| (C) Radical polymerization | C-1 | 0.021 | 0.017 | 0.017 | 0.017 | 0.017 | 0.024 | 0.010 | 0.103 | 0.035 |
| inhibitor | C-2 | | | | | | | | | |
| | C-3 | | | | | | | | | |
| (D1) Electrically conductive | D1-1 | 43.00 | 43.00 | 43.00 | 43.00 | 43.00 | 40.00 | 46.00 | | |
| particles | D1-2 | 43.00 | 43.00 | 43.00 | 43.00 | 43.00 | 40.00 | 46.00 | | |
| (D2) Insulating particles | D2-1 | | | | | | | | 5.000 | 35.000 |
| | D2-2 | | | | | | | | 5.000 | 35.000 |

| | | | | | | | | | |
|---|---|---|---|---|---|---|---|---|---|
| 70° C. Curing properties | A | A | A | A | A | A | A | A | A |
| Viscosity [Pa · s] | 25 | 27 | 23 | 28 | 25 | 22 | 34 | 28 | 63 |
| Die shear strength [N/mm²] | 4 | 6.7 | 4 | 7.3 | 4.2 | 7.5 | 7.5 | 8.4 | 7.9 |
| Normal-temperature elastic modulus [GPa] | 0.4 | 0.6 | 0.5 | 0.7 | 0.4 | 0.4 | 0.4 | 0.3 | 0.5 |
| Pot life [hour h] | 48 | 30 | 48 | 20 | 48 | 30 | 30 | 24 | 30 |
| Overall evaluation | A | A | A | A | A | A | A | A | A |

TABLE 3

| | | Comparative | Comparative | Comparative | Comparative | Comparative |
|---|---|---|---|---|---|---|
| | | Example 1 | Example 2 | Example 3 | Example 4 | Example 5 |
| (A) Radically polymerizable | A1-1 | | | | | |
| curable resin | A1-2 | | | | | |
| | A1-3 | | | 1.27 | 1.27 | |
| | A1-4 | | | | | |
| | A1-5 | | | | | |
| | A1-6 | | | | | |
| | A1-7 | 1.27 | | | | |
| | A1-8 | | 1.27 | | | |
| | A2-1 | 6.54 | 6.54 | 6.54 | 6.54 | 7.22 |
| | A2-2 | 1.75 | 1.75 | 1.75 | 1.75 | 1.93 |
| | A3-3 | 3.88 | 3.88 | 3.88 | 3.88 | 4.28 |
| (B) Radical polymerization | B-1 | 1.35 | 1.35 | 1.35 | 1.35 | 1.35 |
| initiator | B-2 | | | | | |
| (C) Radical polymerization | C-1 | 0.017 | 0.017 | | | 0.017 |
| inhibitor | C-2 | | | 0.017 | | |
| | C-3 | | | | 0.017 | |
| (D1) Electrically conductive | D1-1 | 43.00 | 43.00 | 43.00 | 43.00 | 43.00 |
| particles | D1-2 | 43.00 | 43.00 | 43.00 | 43.00 | 43.00 |
| (D2) Insulating particles | D2-1 | | | | | |
| | D2-2 | | | | | |

| 70° C. Curing properties | A | B | A | B | A |
|---|---|---|---|---|---|
| | | (Partly uncured) | | | |
| Viscosity [Pa · s] | 22 | 108 | 23 | 23 | 20 |
| Die shear strength [N/mm²] | 9.9 | 1.6 | 3.9 | — | 10.5 |
| Normal-temperature elastic modulus [GPa] | 1.69 | 0.2 | 0.9 | — | 1.99 |
| Pot life [hour h] | 24 | 48 | <6 | >72 | 24 |
| Overall evaluation | B | B | B | B | B |

### (Physical Property Values)

By a method explained below, measured physical property values of the resin compositions according to Examples and Comparative Examples were evaluated.

### (70° C. Curing Properties)

It was observed by visual inspection and finger touch whether a sample portion of a test piece used in the measurement of die shear strength is solidified. When solidification of the sample portion of the test piece was observed by visual inspection and finger tough, the evaluation was indicated with “A”. When solidification of the sample portion of the test piece was not observed by visual inspection or finger tough, the evaluation was indicated with “B”. It is noted that whether it was cured at 70° C. can also be evaluated by the later-described die shear strength.

### (Viscosity)

The viscosity of each resin composition was measured at 10 rpm using a Brookfield RVT-type viscometer (spindle: SC4-14 spindle, measurement temperature: 25° C.). When the measured viscosity is 100 (Pas) or less, the resin composition was evaluated as acceptable. The results are illustrated in Tables 1 to 3 above.

### (Die Shear Strength)

As a substrate, a glass substrate was prepared. As a die, a 3 mm Si die was prepared. Using a polyimide film stencil having a @2 mm hole (thickness: 120 μm), each resin composition was printed on the glass substrate. Thereafter, the 3 mm Si die was mounted in an air convention oven to perform curing at 70° C. for 60 minutes. In this manner, a sample for measuring die shear strength was prepared. Using a benchtop strength tester (model No.: 4000PLUS-CART-S200 KG) manufactured by Nordson DAGE, the die shear strength was measured at room temperature.

In each of Examples and Comparative Examples, ten samples for measuring die shear strength were measured. The arithmetic average value of the obtained ten measured values was defined as the die shear strength. When the die shear strength is 2 (N/mm²) or more, the resin composition was evaluated as acceptable. The results are illustrated in Tables 1 to 3 above. It is noted that Comparative Example 4 was unmeasurable.

### (Normal-Temperature Elastic Modulus)

Each resin composition was applied on a microscope slide attached with a Teflon tape (Teflon is registered trademark) to have a film thickness of 200±50 μm when cured. Accordingly, a coat was formed. Thereafter, the coat was left to stand at 70° C. for 60 minutes in an air convention oven and thus cured. The cured coat was peeled from the microscope slide attached to a Teflon tape. Thereafter, a test piece having a prescribed size (40 mm×5 mm) was cut out from the cured coat. The cut edge was finished to be smooth with sandpaper. The normal-temperature elastic modulus of this test piece was measured in accordance with JIS C6481 using a viscoelasticity measuring device (DMA) (model No.: DMS7100) manufactured by Hitachi High-Tech Science Corporation, under the conditions of deformation mode: Tension, measurement mode: Ramp, frequency: 10 Hz, strain amplitude: 5 μm, minimum tension/compression: 50 mN, tension/compression gain: 1.2, force amplitude initial value: 50 mN, movement waiting time: 8 sec, creep waiting time factor: 0, and 25° C. When the measured normal-temperature elastic modulus is 1.6 (GPa) or less, the resin composition was evaluated as acceptable. The results are illustrated in Tables 1 to 3 above. In Comparative Example 4, the normal-temperature elastic modulus was unmeasurable.

### (Pot Life)

The viscosity (viscosity immediately after the preparation) of an adhesive composition immediately after preparation and the viscosity (viscosity of an adhesive composition) of an adhesive composition after left to stand for a prescribed time (standing time) at room temperature (25° C.) were measured at 10 rpm using a Brookfield RVT-type viscometer (spindle: SC4-14 spindle, measurement temperature: 25° C.). Then, the ratio of the viscosity change of an adhesive composition, when the viscosity immediately after preparation is set to 1.0, was calculated as the thickening ratio. The larger the thickening ratio, the higher the viscosity of the adhesive composition with time. Therefore, when the thickening ratio is large, it can be said that the resin composition is closer to a state of being unusable as an adhesive. Conversely, when the thickening ratio is small, it is indicated that the viscosity change has hardly occurred with time. Therefore, it can be said that the resin composition maintains a state of being usable as an adhesive. That is, when the thickening ratio is small, it can be said that the resin composition has a long pot life. In Examples and Comparative Examples, a standing time until the thickening ratio reaches 1.5 or more is illustrated. When the standing time is 6 hours or more, the resin composition was evaluated as acceptable.

### (Overall Evaluation)

When all the measurement results satisfied the acceptable criteria, the resin composition was evaluated as “A”. When at least one of the measurement results did not satisfy the acceptable criteria, the resin composition was evaluated as “B”. Also, “-” indicates that the test piece is not in a state of being measurable.

In each of Examples, all measurement results satisfied the acceptable criteria.

In Comparative Example 1, (A1) the urethane acrylate oligomer used has a small mass average molecular weight. Therefore, the normal-temperature elastic modulus did not satisfy the acceptable criteria.

In Comparative Example 2, (A1) the urethane acrylate oligomer used has a large mass average molecular weight. Therefore, the resin composition was partly uncured in the curing at 70° C. As a result, both the viscosity and the die shear strength did not satisfy the acceptable criteria.

In Comparative Example 3, the resin composition does not contain (C1) the nitrosamine compound. Therefore, the pot life did not satisfy the acceptable criteria.

In Comparative Example 4, the resin composition does not contain (C1) the nitrosamine compound. Therefore, the resin composition was not cured in the curing at 70° C. As a result, the die shear strength and the normal-temperature elastic modulus themselves were unmeasurable.

In Comparative Example 5, (A1) the urethane acrylate oligomer is not used. Therefore, the normal-temperature elastic modulus did not satisfy the acceptable criteria.

These results demonstrated that a resin composition including (A) a radically polymerizable curable resin, (B) a radical polymerization initiator, and (C) a radical polymerization inhibitor, in which the (C) component contains (C1) a nitrosamine compound, the (A) component contains (A1) a urethane acrylate oligomer, and the (A1) component has a mass average molecular weight of 1,600 or more and 20,000 or less, has low elasticity, is excellent in low-temperature curing properties, and has a long pot life.

1. A resin composition comprising:
(A) a radically polymerizable curable resin;
(B) a radical polymerization initiator; and
(C) a radical polymerization inhibitor, wherein
the (C) component contains (C1) a nitrosamine compound,
the (A) component contains (A1) a urethane acrylate oligomer, and
the (A1) component has a mass average molecular weight of 1,600 or more and 20,000 or less.

2. The resin composition according to claim 1, wherein
the (B) component is contained in an amount of 0.1 part by mass to 30 parts by mass with respect to 100 parts by mass of the (A) component,
the (B) component contains an organic peroxide, and
the organic peroxide has a 10-hour half-life temperature of 165° C. or lower.

3. The resin composition according to claim 1,
wherein the (A) component further contains (A3) a bismaleimide resin.

4. The resin composition according to claim 1,
wherein the (A) component further contains (A2) an acrylate monomer.

5. The resin composition according to claim 4,
wherein (A2) the acrylate monomer contains an acrylate monomer having a glass transition temperature (Tg) of 15° C. or higher.

6. The resin composition according to claim 1,
wherein the (A1) component is contained in an amount of 5 parts by mass to 50 parts by mass with respect to 100 parts by mass of the (A) component.

7. The resin composition according to claim 4,
wherein a mass ratio between (A1) the urethane acrylate oligomer and (A2) the acrylate monomer is 5:95 to 60:40.

8. The resin composition according to claim 1,
wherein the (C) component is contained in an amount of 0.1 part by mass to 5 parts by mass with respect to 100 parts by mass of the (B) component.

9. The resin composition according to claim 1,
which has a normal-temperature elastic modulus of 0.01 GPa to 1.6 GPa after left to stand at 70° C. for 60 minutes.

10. The resin composition according to claim 1,
which contains insulating particles.

11. The resin composition according to claim 1,
which contains electrically conductive particles.

12. The resin composition according to claim 1,
which is used in flexible hybrid electronics applications.

13. An electrically conductive adhesive comprising
the resin composition according to claim 1.

14. A cured product of
the resin composition according to claim 1.

15. A semiconductor device comprising
the electrically conductive adhesive according to claim 13.
